(19) United States
(12) Patent Application Publication
(10) Pub. No.: US 2025/0173949 A1
(43) Pub. Date: May 29, 2025

(54) MAPPING VISIBILITY STATE TO TEXTURE MAPS FOR ACCELERATING LIGHT TRANSPORT SIMULATION

(71) Applicant: NVIDIA Corporation, Santa Clara, CA (US)

(72) Inventor: Rasmus Johannes DELIGIANNIS, Stockholm (SE)

(73) Assignee: NVIDIA Corporation, Santa Clara, CA (US)

(21) Appl. No.: 18/522,683

(22) Filed: Nov. 29, 2023

(51) Int. Cl. G06T 15/04; G06T 15/06

(52) U.S. Cl. CPC G06T 15/04; G06T 15/06

(57) ABSTRACT

In various examples, systems and methods are disclosed relating to image state mapping. A processor can identify a visual characteristic for a shape element mapped to locations of a map. The processor can determine whether the shape element intersects a boundary of the map. The boundary can correspond to a threshold value for the visual characteristic. The processor can assign a state for controlling generation of an image to the shape element. The assignment can be responsive to the determination of the intersection and according to the visual characteristic.

### BACKGROUND

Raytracing is a technique of light transport simulation that can simulate the way light interacts with objects to generate realistic images. In conventional raytracing implementations, one or more paths of light (e.g., a ray) are simulated for each pixel, and the interactions of each sampled ray in a scene are computed and tracked as the rays proceed through, reflect from, or terminate at objects in the scene. However, raytracing can be computationally expensive, because ray behavior at an interface with a material can include various mathematical calculations. Further, because conventional techniques often use one or more rays for each pixel of an image, the sheer number of rays and a complexity of their interactions can lead to substantial computational demand. Such complexity is compounded for real-time raytracing, wherein the raytracing calculations should be performed prior to a next frame rendering. Although some circuits can include hardware dedicated to raytracing, a number of available circuits can be limited, and increasing a number of circuits can crowd out other circuit elements, increase a die or package size, or otherwise increase a complexity or power usage of a device.

### SUMMARY

Implementations of the present disclosure relate to systems and methods for image state mapping, such as for mapping visibility state to texture maps for accelerating light transport simulation. One or more processors or other components described herein can determine a state for a shape element. The state can include an indication of a visual characteristic of an object which is relevant to raytracing (e.g., transparency). The state of the object can be stored in a data structure accessible to a run-time device. The run-time device can map a shape element to a data object. At run-time, the run-time device can determine that a ray intersects with a surface of the data object corresponding to the mapped shape element. The run-time device can further, at run-time, retrieve a stored state and can determine ray propagation based thereupon. For example, an object which is opaque, differently colored than a light source, etc., can cause the ray to terminate, such that the run-time device can determine a termination of the ray and can dedicate device resources to further process unresolved rays.

At least one aspect relates to a processor. The processor can include one or more circuits to identify a visual characteristic for a shape element mapped to a plurality of locations of a map. The one or more circuits can determine whether the shape element intersects a boundary of the map, the boundary corresponding to a threshold value for the visual characteristic. The one or more circuits can assign, responsive to the determination of the intersection and according to the visual characteristic, a state to the shape element for controlling generation of an image comprising the shape element.

In some implementations, the processor can include one or more second circuits to identify an interface (interaction site) between a simulated ray and the shape element. The one or more second circuits can determine an absorption or propagation of the ray at the interface according to a criterion corresponding to the state of the shape element.

In some implementations, the processor can include one or more second circuits to identify an interface between a simulated ray and the shape element. The one or more second circuits can retrieve, responsive to the state of the shape element, a representation of the shape element comprising an indication of the boundary. The one or more second circuits can determine an absorption or propagation of the ray at the interface criteria determined based at least on the state of the representation of the shape element.

In some implementations, the state assigned to the shape element is represented using a first bit, indicative of the intersection with the boundary and/or a second bit indicative of the visual characteristic. In some implementations, a location of the plurality of locations includes a center point of a cell disposed in a grid. In some implementations, the boundary is defined according to a polynomial function of the grid. In some implementations, the map is a two-dimensional texture map that maps a projection of a three-dimensional data object to a two-dimensional image. In some implementations, the boundary is defined according to a bilinear sampling of a two-dimensional texture map.

In some implementations, the visual characteristic is a binary indication of an opacity (e.g., of a surface of the object incident to the sampled ray). The shape element can be a triangle. The opacity can be identified by comparing a map location bounded by the triangle to the threshold value.

At least one aspect relates to a system. The system can include one or more circuits to identify a visual characteristic for a shape element mapped to a plurality of locations of a map. The one or more circuits can determine whether the shape element intersects a boundary of the map, the boundary corresponding to a threshold value for the visual characteristic. The one or more circuits can assign, responsive to the determination of the intersection and according to the visual characteristic, a state to the shape element for controlling generation of an image comprising the shape element.

In some implementations, the system includes one or more second circuits. The one or more second circuits can identify an interface between a simulated ray and the shape element. The one or more second circuits can determine an absorption or propagation of the simulated ray at the interface according to a criterion corresponding to the state of the shape element.

In some implementations, the system includes one or more second circuits. The one or more second circuits can identify an interface between a simulated ray and the shape element. The one or more second circuits can retrieve, responsive to the state of the shape element, a representation of the shape element comprising an indication of the boundary. The one or more second circuits can determine an absorption or propagation of the simulated ray at the interface according to criteria determined based at least on the state of the representation of the shape element.

In some implementations, the state is represented using a first bit indicative of the intersection with the boundary and/or a second bit indicative of the visual characteristic. In some implementations, the texture map is a two-dimensional texture map, and the boundary is defined according to a bilinear sampling of the two-dimensional texture map. In some implementations, the visual characteristic is a binary indication of an opacity. The shape element can be a triangle. The opacity can be identified by comparing a map location bounded by the triangle to the threshold value.

At least one aspect relates to a method. The method can be performed by a data processing system including one or more computing devices. The method can include identifying a visual characteristic corresponding to a shape element mapped to a plurality of locations of a texture map. The method can include determining whether the shape element intersects a boundary of the texture map, the boundary corresponding to a threshold value for the visual characteristic. The method can include assigning, to the shape element, a state for controlling generation of an image comprising the shape element, responsive to the determination of the intersection and according to the visual characteristic.

In some implementations, a location of the plurality of locations comprises a center point of a cell disposed in a grid. The boundary can be defined according to a polynomial function of the grid. The state can be represented using a first bit indicative of the intersection with the boundary and/or a second bit indicative of the visual characteristic.

In some implementations, the map is a two-dimensional texture map that maps a three-dimensional data object to a two-dimensional image. The boundary can be defined according to a bilinear sampling of a two-dimensional texture map.

In some implementations, the visual characteristic is a binary indication of an opacity. The shape element can be a triangle. The opacity can be identified by comparing a map location bounded by the triangle to the threshold value.

The processors, systems, and/or methods described herein can be implemented by or included in any system that generates a response or output based on input video data, such as at least one of a system associated with an autonomous or semi-autonomous machine (e.g., an AI driver, an in-vehicle infotainment system, a control system, perception system and so on); a system for text-to-video modeling, a system for performing simulation operations; a system for performing digital twin operations; a system for performing light transport simulation; a system for performing collaborative content creation for 3D assets; a system for performing deep learning operations; a system implemented using an edge device; a system implemented using a robot; a system implementing one or more large language models (LLMs); a system for performing conversational AI operations; a system for generating or presenting virtual reality (VR) content, augmented reality (AR) content, and/or mixed reality (MR) content; a system for performing conversational AI operations; a system implementing one or more language models (e.g., large language models (LLMs)); a system for generating and using synthetic data; a system incorporating one or more virtual machines (VMs); a system implemented at least partially in a datacenter; or a system implemented at least partially using cloud computing resources.

### BRIEF DESCRIPTION OF THE DRAWINGS

The present systems and methods for mapping visibility state to texture maps for accelerating light transport simulation are described in detail below with reference to the attached drawing figures, wherein:

FIG. 1 is a block diagram of an example computing environment for shape processing, in accordance with some embodiments of the present disclosure.

FIG. 2 is a flow diagram of an example of a data flow to determine a summation for structures, in accordance with some embodiments of the present disclosure.

FIGS. 3A, 3B, 3C, 3D, and 3E are diagrams illustrating examples of an identification of various polygons corresponding to structures, in accordance with some embodiments of the present disclosure.

FIG. 4 illustrates some examples of ray propagation determination, in accordance with some embodiments of the present disclosure.

FIG. 5 depicts a block diagram of an example of a method for mapping visibility state to texture maps, in accordance with some embodiments of the present disclosure.

FIG. 6 is a block diagram of an example computing device suitable for use in implementing some implementations of the present disclosure, in accordance with some embodiments of the present disclosure.

FIG. 7 is a block diagram of an example data center suitable for use in implementing some implementations of the present disclosure, in accordance with some embodiments of the present disclosure.

### DETAILED DESCRIPTION

This disclosure relates to systems and methods for mapping visibility state to texture maps for accelerating light transport simulation, such as to perform non-conservative shape re-sampling. For example, state data, such as opacity state data from a texture map (sometimes referred to as a UV map), can be resampled to be assigned to shapes used for generating graphics or other image processing operations, such as for raytracing. Shapes can be mapped to constituent shape elements, such as a repeating pattern thereof (e.g., constituent triangles, sometimes referred to as micro-triangles). The shape elements can be sized, selected, or otherwise defined as sub-units of the two-dimensional texture map configured to conform to a three dimensional surface of a data object. An opacity of each shape element can be determined according to an opacity value associated with grid cells associated with the shape element. Each such opacity value can be compared to a threshold to determine a shape element state. For example, the threshold can be configured to determine a binary state (e.g., opaque/transparent or black/white) or to determine a gradated state (e.g., opaque/semitransparent/transparent or a grayscale value according to a predefined number of bits).

Determining the propagation of a ray at an interface with the shape element may be resolved according to a lookup (e.g., where the lookup can check a bit flag or other indication of an opacity of the shape to determine if the shape element is opaque or transparent). However, some shapes may include portions which are opaque, and other portions which are transparent (e.g., a junction of a table or chair leg bordering empty space). Such shapes elements can thus have mixed states (e.g., unknown, unresolved).

To perform operations for rendering or otherwise generating graphics, such as to resolve a ray path (e.g., for raytracing) intersecting a mixed shape, additional or different processing steps may be employed. Further, some opacity information may be smoothed, variable, or otherwise gradated. Thus, the opacity of the shape can be stored in a three-dimensional data object including two spatial dimensions and one (discrete or gradated) opacity dimension. A propagation of a ray (e.g., a reflection, termination, or procession) can depend on the opacity dimension of the three-dimensional data object.

Systems and methods in accordance with the present disclosure can reduce a number of mixed state shape elements identified for one or more data objects (e.g., a virtual table or chair), relative to other techniques. For example, conservative techniques may use aligned-axis bounding boxes (AABBs) to define a bounding box around a shape which generally extends over a larger dimension than the shape, such that the shape is guaranteed to be bounded by the bounding box, but which are over-conservative in that they include additional search area. Variants, such as conservative rasterization, can remove individual texels associated with the bounding box which do not intersect the shape, but the search area will still generally exceed the shape dimension, which can lead to classifying resolvable shapes as potentially unresolved, which can correspond to performance of the additional or different processing steps referred to above.

Thus, it may be advantageous to reduce a number of shape elements identified as having a mixed state. For example, a conservative resampling method may result in assignment of 10% of shape elements as mixed state, wherein, according to the systems and methods disclosed herein, an identification of 7% of the shape elements may be assigned as mixed state. Thus, according to the systems and methods employed herein, additional or different processing steps employed to resolve the mixed state may be reduced by 30%, presuming random distribution of rays. In some instances, such as a computer vision system configured to perform edge detection, or a video game where a player may be interested in an appearance of an opponent from behind cover (e.g., a bush or edge of a windowsill), a relative focus on object boundaries may exceed a random distribution. Hence, according to the preceding example, the additional or different processing steps employed to resolve the mixed state may be reduced by an amount exceeding 30%. Such reductions in operation can reduce memory usage or processor cycles, increase frame rates, etc.

A system can receive a texture map comprising one or more shapes (e.g., polygons). Some portions of the polygons may be opaque (e.g., a representation of an object in a virtual space such as in computer graphics, virtual reality, or computer vision). For example, a representation of an object such as the table or chair can include opaque portions, corresponding to depictions of wood or metal portions thereof, along with transparent portions, such as a spacing between legs of the table or chair, translucent glass or plastic, or so forth. The shapes can be (or be disaggregated into) shape elements which are processed by the systems and devices described herein.

The texture map can be resampled, such as according to a bilinearly sampled technique to generate a smoothed depiction. For example, the bilinear sampling can be applied to colors (e.g., gradient shading), jagged edges/stairstep effect (e.g., anti-aliasing), as well as opacity, according to the present disclosure. Although the present illustrative example is provided in regard to opacity, in various embodiments, some operations may depend upon other classification of the shapes. For example, a reflection of a ray can depend upon a non-conservative reflectivity sampling, such that a reflectivity threshold determines a termination or reflection of a ray.

The resampled texture map can be projected onto a map, such as a two dimensional grid comprising cells extending in an ‘X’ direction and a ‘Y’ direction. A further, ‘Z’ dimension can define an opacity, such as an opacity varying between 0 and 1, 0% and 100%, etc. A threshold, such as a predefined, fixed threshold (e.g., 0.5 or 50%), can be visualized as a two dimensional plane intersecting the three dimensional representation of the texture map. Thus, lines extending along the intersection define a boundary between portions of the texture map exceeding the threshold from portions which do not exceed the threshold (and may be referred to as a boundary for the opacity or other visual characteristic).

A shape element can occupy one or more cells of the grid according to a dimension, scaling, and the like. The system can evaluate whether any triangle edge intersects the boundary to determine whether the shape element straddles (intersects) a boundary. If the shape element does not intersect the boundary, it may be possible that the shape element is resolvable, but, in some instances, will not be. For example, an inclusion or occlusion within the shape element may not result in an intersection.

Some shape elements can be assigned a known state, wherein every portion of such a shape element has a same opacity or other visual characteristic (e.g., every location of the shape element exceeds the threshold, or every location of the shape does not exceed the threshold). Other shape elements can be assigned a mixed state (e.g., the state cannot be known because some locations of such a shape element exceed the threshold and others do not exceed the threshold).

The system can determine, for each cell bounded by the shape element, a classification for the cell based on an opacity state of a center point of the cell. That is, the opacity state of the center point of each cell bounded by the shape element can be compared to the opacity threshold. The system can identify a match or mismatch between the various cells. That is, if one center points of the cells are mismatched (e.g., some are transparent and others are non-transparent), then an inclusion or occlusion is present, or the shape element straddles the boundary line, and cannot, in either case, be resolved. A suitable sampling technique, such as bilinear sampling can ensure that a center point is a local maximum or minimum of cells where no intersection exists. However, such a determination may not classify some shape elements, when not employed in combination with the intersection test described above. For example, a vertex or edge of the triangle may extend somewhat into a cell which is not bounded, or an adjoining cell can cause a cell center to deviate from a cell edge or other portion bounded by the shape element. Thus, by the combination of the selection of a suitable sampling technique, the intersection detection, and the sampling of the various locations bounded by the shape element, a reduced number of unresolved shape elements may be identified, which can reduce additional operations to resolve such shapes during, for example, a runtime operation.

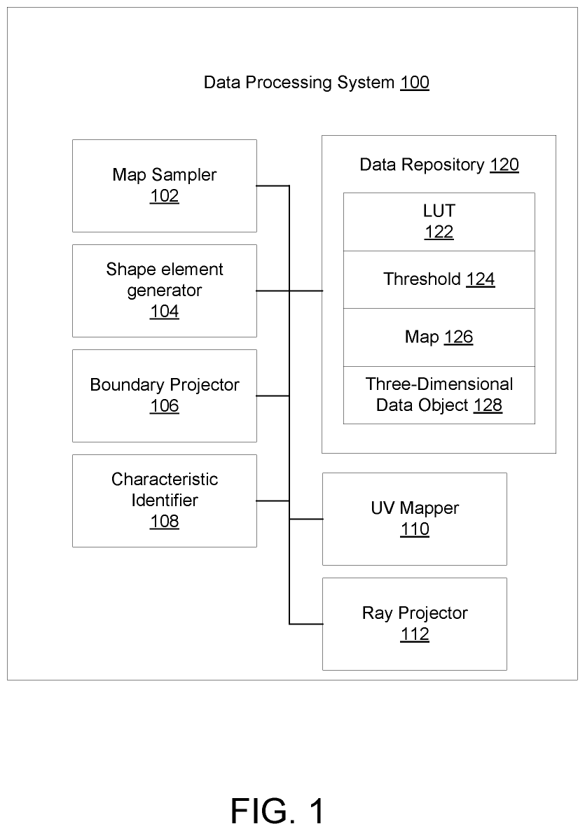

With reference to FIG. 1, an example computing environment for mapping visibility states is provided, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The data processing system 100 can process shape elements to determine derivative information thereof, such as to determine constituent shapes such as micro-triangles, each micro-triangle comprising data associated with a visual characteristic, such as opacity. The data processing system 100 can include any number of computing devices.

The data processing system 100 can include one or more map samplers 102. The map samplers 102 can sample a data map 126, such as according to a bilinear sampling technique. The data processing system 100 can include one or more shape element generators 104. The shape element generators 104 can generate a shape corresponding to a data map 126. The data processing system 100 can include one or more boundary projectors 106. The boundary projectors 106 can define a boundary of a data map 126 associated with a visual characteristic. The data processing system 100 can include one or more characteristic identifiers 108. The characteristic identifiers 108 can identify one or more characteristics of the shape elements defined by the shape element generator 104. The data processing system 100 can include one or more UV mappers 110. The UV mapper 110 can project a data map 126 onto a data object. The data processing system 100 can include one or more ray projectors 112. The ray projector can determine an interface between a ray and a shape element.

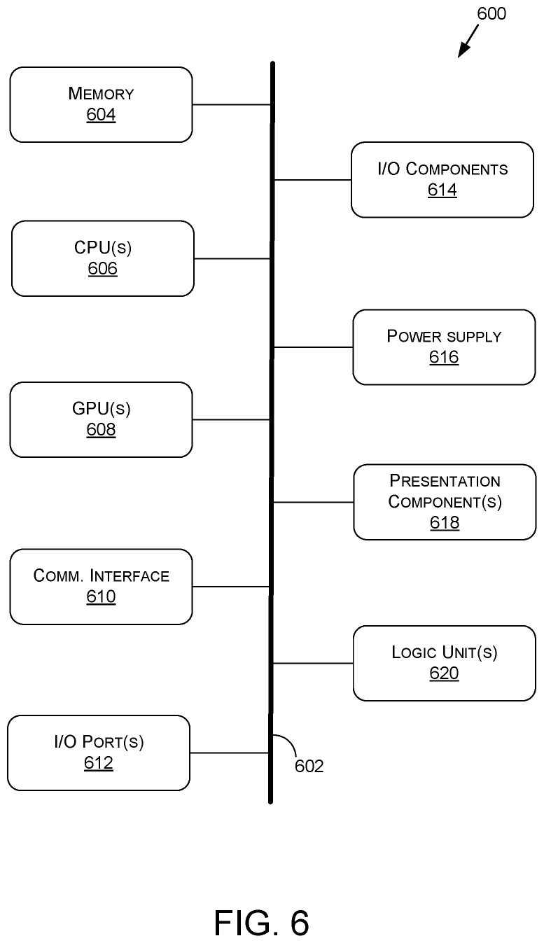

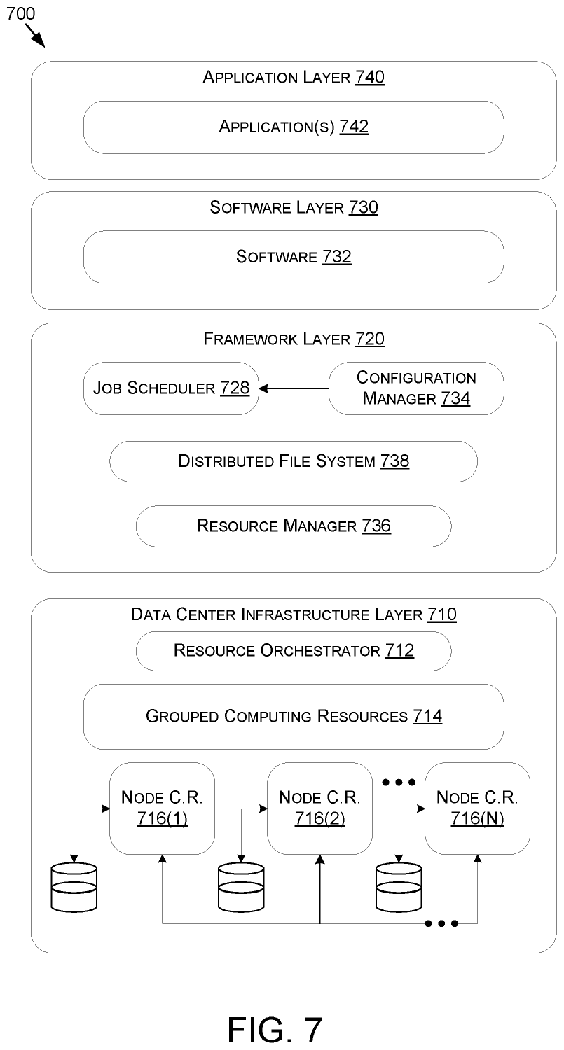

The map sampler 102, shape element generator 104, boundary projector 106, characteristic identifier 108, UV mapper 110, and/or ray projector 112 can each include or be implemented by at least one processing unit or other logic device such as a programmable logic array engine, or module configured to communicate with a data repository 120 or database. The map sampler 102, shape element generator 104, boundary projector 106, characteristic identifier 108, UV mapper 110, or ray projector 112 can be separate components, a single component, or part of the data processing system 100. The data processing system 100 can include hardware elements, such as one or more processors, logic devices, or circuits. For example, the data processing system 100 can include a first device or sub-system including the map sampler 102, shape element generator 104, boundary projector 106, and characteristic identifier 108. The first computing device or sub-system can define a state of various representations of the shape element. The data processing system 100 can further include a separate device or subsystem including the UV mapper 110 and ray projector 112. The second computing device can determine ray propagation based on the states defined by the first device or subsystem. The first computing device and the second computing device can include any computing device of, for example, FIG. 6 or FIG. 7.

The data repository 120 can include one or more local or distributed databases, and can include a database management system. The data repository 120 can include computer data storage or memory and can store one or more data structures, such as a look up table (LUT) 122, threshold 124, map 126, and/or three-dimensional data object 128. The data repository 120 can include elements accessible to some or all of the components of the data processing system 100 (e.g., cloud or networked storage). The data processing system 100 can include distributed devices or subsystems which can access a portion of the data structures of the data repository 120 according to data stored proximal thereto (e.g., local storage).

The LUT 122 can include any data structure including an indication of a state corresponding to a visual characteristic. The visual characteristic can be a feature for visual representation (e.g., rendering, display) of data. The visual characteristic can include, for example, a color, opacity, reflectivity, surface roughness, or any of other characteristic which is itself visible or is relevant to a propagation of a ray. The visual characteristic can correspond to a shape element or portion or representation thereof. For example, the indication of the state can be provided on a micro-triangle basis. The state can include a quantitative, qualitive, and/or categorical value of the visual characteristic. The state can be stored as a maximum, minimum, average, other data aggregation for a visual characteristic, or according to a bitflag which is descriptive of every portion of the shape element or a portion thereof. For example, the bitflag can include a binary indication of a presence or an absence of a visual characteristic (e.g., alpha tested opacity).

The state (e.g., a presence or an absence thereof) can correspond to a spectrum. The indication can correspond to one or more thresholds 124 associated with the spectrum. For example, the state can include an indication that the visual characteristic of the shape element does or does not exceed a threshold 124. The threshold 124 can correspond to a color, opacity, reflectivity, or other attribute. The spectrum can be continuous or discrete. For example, a visual characteristic can be defined according to a polynomial function, or digitally encoded information (e.g., 8-bit, 16-bit, or 24 bit color depth).

Some shape elements can include more than one visual characteristic corresponding to different portions of the shape elements. For example, a micro-triangle can include a first portion which is opaque and a second portion which is transparent. The micro-triangle can be a micro-triangle of a UV map of an opaque object, wherein the micro-triangle is disposed across a boundary of a filled portion of the UV map (sometimes referred to as an ‘island’) with an unfilled portion (sometimes referred to as ‘interstitial’ or ‘negative space’). The LUT 122 can include an indication of such a state, which may be referred to as a mixed state.

In some implementations, the LUT 122 can include two bits for each micro-triangle, wherein a first bit corresponds to a comparison of an opacity to a threshold 124, and the second bit corresponds to a mixed stated-ness of the micro-triangle (e.g., the second bit can have a first value based on the micro-triangle having a same or non-mixed state, and a second value based on the micro-triangle having a mixed state). The mixed stated-ness can be represented as a binary indication, such that when every location of a shape element corresponds to a same visual characteristic, relative to the threshold, the bit indicates a corresponding bit value (e.g., a zero). If two or more locations of the shape vary, indicating that shape element is a mixed-state shape element, a different bit value (e.g., a one) may be provided. Thus, upon accessing the LUT 122, a processing circuit can determine whether a shape element is a mixed state shape element, and for non-mixed state shape element, what the state of the shape is (e.g., opaque or transparent).

The LUT 122 can be available to any portion of the data processing system 100. For example, the LUT 122 can be generated at a first sub-system of the data processing system 100. The data processing system 100 can convey the LUT 122 to a second sub-system, whereupon the second sub-system can instantiate a ray, and can access the LUT 122 to determine a propagation of the ray based on the LUT data. For example, the LUT 122 can include opacity data, wherein a termination, reflection, or propagation of the ray is based on the LUT data.

The threshold 124 can include one or more values corresponding to two or more states of a visual characteristic. For example, an opacity threshold 124 can include a binary indication of opacity which may be set at, for example, 10%, 50%, 90%, or another threshold value. Some thresholds 124 can include more than one value, such as a first threshold 124 of 10%, a second threshold 124 of 50%, or a third threshold 124 as 90%. The multiple thresholds 124 can define multiple states (e.g., transparent, semi-transparent, and opaque). The multiple thresholds can be selectable according to a client device, such as to modulate a number of raytracing interfaces evaluated (e.g., selecting a higher opacity threshold 124 can result in a termination of rays to reduce raytracing calculations).

The threshold 124 can be available to any portion of the data processing system 100. For example, the boundary projector 106 can access the threshold 124 to define a boundary. The UV mapper 110 or ray projector 112 can access one or more thresholds 124 (e.g., to select a corresponding portion of a data structure associated with a desired threshold 124), or may not access threshold data itself (e.g., in the case of a single threshold 124 encoded into LUT 122 data).

The map 126 can include a digital image or other asset that serves as a representation of visual surface characteristics, such as a texture map 126 or other data map 126. The map 126 can include various representations, such as an opacity map, color map, etc. The map 126 can be a two-dimensional map configured for application to a three-dimensional data object 128 (e.g., according to a UV map thereof). The map 126 can include a grid to define a location corresponding to the information disposed along a surface thereof. The map 126 can include various data associated with a visual characteristic. For example, the map 126 can include an indication of opacity, colors, reflectivity, or other visual characteristics.

The map 126 can proceed through various transformations. For example, a first map 126 can refer to a raster image. A transformation of the first map 126 can yield a second map 126. The second map 126 can include a smoothed feature, relative to the raster image. A transformation of the second map 126 can yield a third map 126. The third map 126 can include a gradient dimension. A further transformation of the third map 126 can yield a fourth map 126 (e.g., a texture map 126).

The map 126 can be available to any portion of the data processing system 100. For example, the map sampler 102 can sample the map to define a representation thereof (e.g., as smoothed representational), and the UV mapper 110 can access the map 126 fit the map 126 to a three-dimensional data object 128.

The three-dimensional data object 128 can include any object including a surface configured to interface with the map 126. For example, in a computer vision application (e.g., AR), the three-dimensional data object 128 can correspond to a real-world wall, person, object, or the like, or a virtual overlay or object (e.g., navigation arrow or data box). In other computer graphics applications, the three-dimensional data objects 128 can include characters, objects, environments (e.g., skies, walls, or vistas). The three-dimensional objects 128 are accessible at least to the UV mapper 110 (to fit the map to the three-dimensional objects 128) and the ray projector (e.g., to determine interfaces between a portion of the three-dimensional object 128 and a ray).

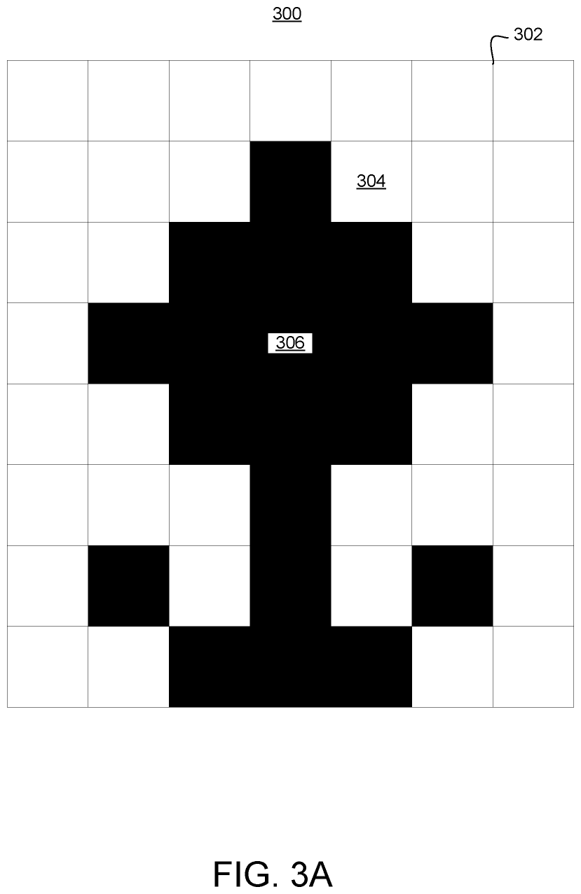

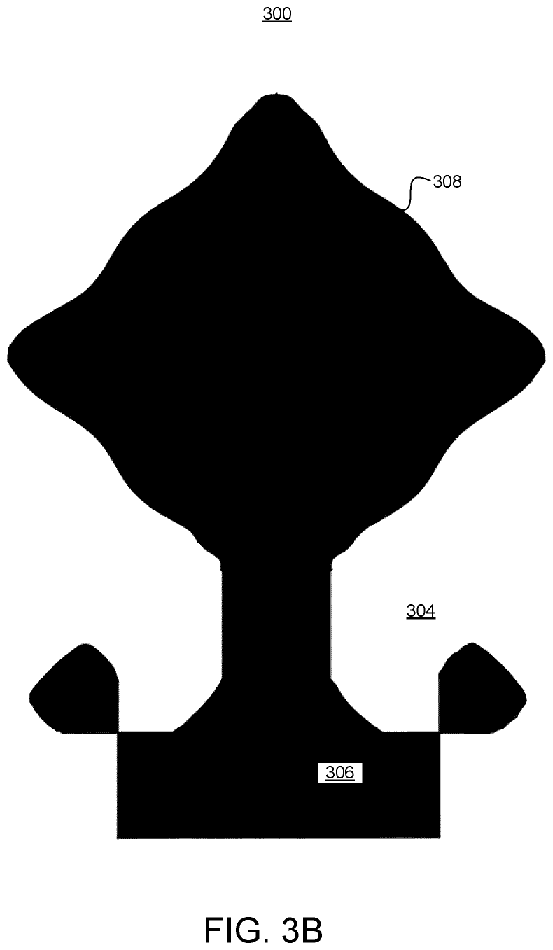

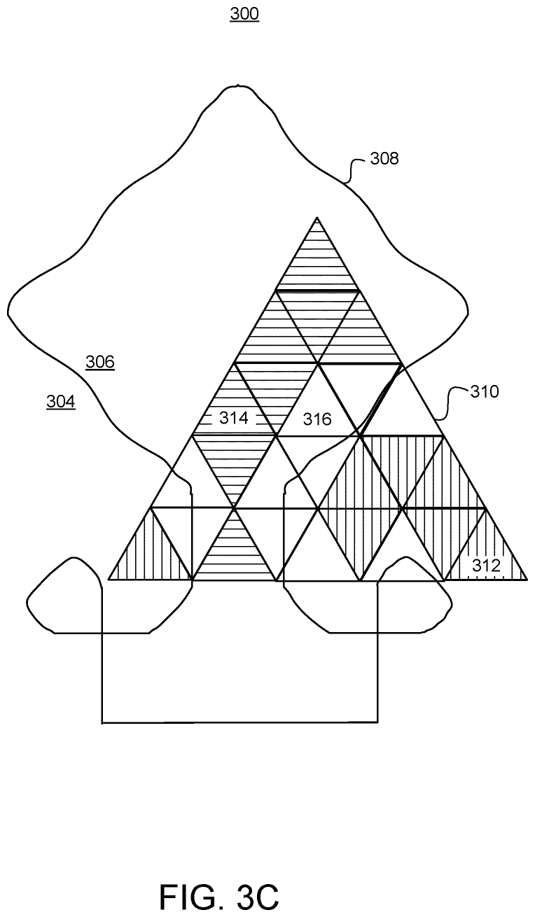

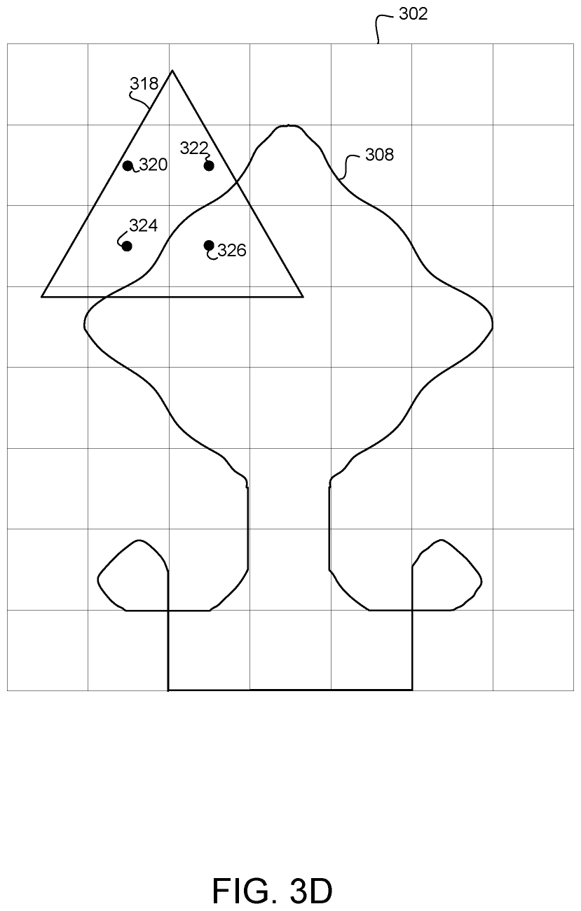

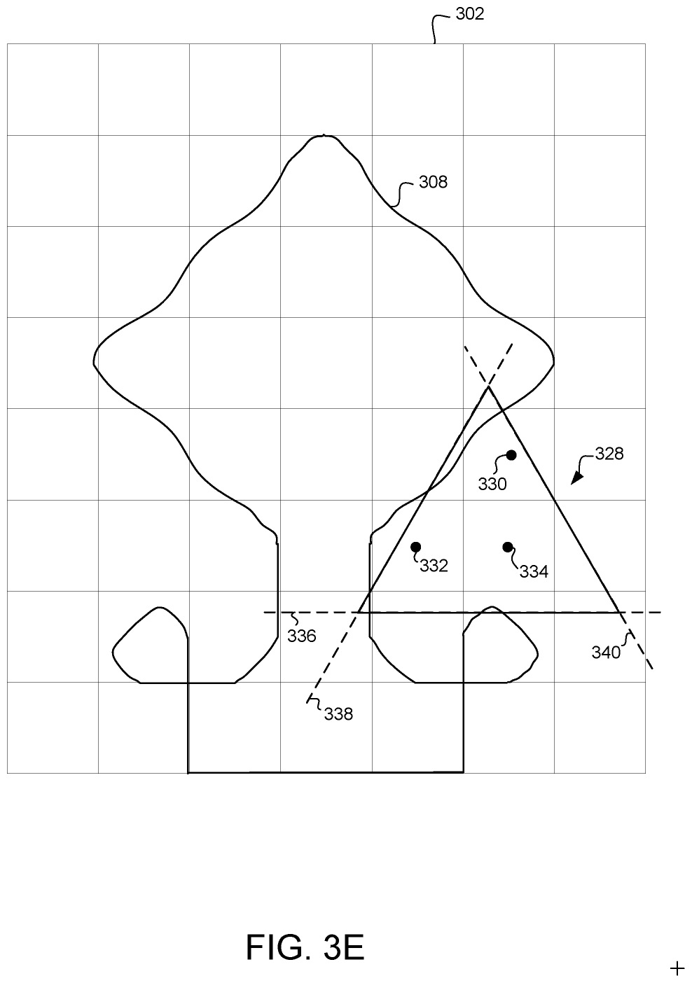

Referring further to FIG. 1, the map sampler 102 can sample a data map 126 to generate a representation thereof. The representation can include, for example, a rasterized representation, a smoothed or otherwise sampled representation, or another representation associated with a data map 126. For example, the map sampler 102 can receive a first data map 126 including a raster image. An example raster image is provided henceforth, at FIG. 3A. A raster image can include pixel-defined information which relates to one or more visual characteristics. The map sampler 102 can perform various operations on the data map 126 to generate a representation thereof configured for display or other operations. For example, the map sampler 102 can employ anti-aliasing, application of gaussian blurs, smoothing filers, bilateral filters, or resampling (e.g., upscaling, downscaling).

The map sampler 102 can generate a map 126 including gradient data. For example, the gradient information can include a gradated representation of information received from the raster image. For example, the raster image can include pixels of predefined visual characteristics (e.g., a zero, a one, or another value therebetween, the value corresponding to an entirely transparent or entirely opaque characteristic). The zero or one can refer to, for example, a float value which various between zero or one, or another value (e.g., an 8-bit register) such that the value can be encoded according to a value between 0 and 255. That is, references to zero and one herein may refer to normalized values, which may be stored according to various formats.

In some implementations, the resampling operations employed by the map sampler 102 include bilinear sampling. The map sampler 102 can perform bilinear sampling by interpolating between adjacent values (e.g., pixels) to generate an output value. The interpolation can blend values (e.g., pixels) based on their relative distances to the sampled location, providing a smoother transition between locations of a data map 126. The map sampler 102 can bilinearly sample one or more attributes of the data map 126, such as a color, opacity, reflectivity, etc. The bilinear sampling can be performed relative to the rasterized image, such that a center point of each cell of the resampled data map 126 can represent a local maximum or minimum of the cell. According to some implementations, other resampling operations (e.g., bicubic, gaussian, spline, or other resampling techniques) may be employed. In some such implementations, the pixel centers may not correspond to a local minimum or maximum of the portion of the data map 126 corresponding to the pixel.

The map sampler 102 can define one or more gradients of the visual characteristic of the data map 126. The map sampler 102 can define the one or more gradients according to a polynomial function, another grid (e.g., a higher resolution grid than a grid of a received rasterized image), or other techniques. The data map 126 can include one or more portions (e.g., islands) which correspond to a gradient exceeding a threshold 124, and one or more portions (e.g., cavities) which correspond to a gradient which does not exceed the threshold 124.

The shape element generator 104 can generate a shape corresponding to a data map 126. For example, the shape can be a polygon (e.g., a triangle) which may correspond to a face of an object, such as an object, character, or environment generated in a computer graphics environment. The shape element generator 104 can subdivide (e.g., tessellate) shape elements to generate further shape elements (e.g., constituent micro-triangles).

Some of the shape elements can correspond to facings of a texture map 126. For example, the shape elements can be configured for placement, by the UV mapper 110, for placement in conjunction with (e.g., over a surface of) a three-dimensional data object 128. Further shape elements (e.g., constituent micro-triangles) can be defined according to a subdivision (e.g., tessellation) of the shape elements according to a repeating pattern thereof.

The boundary projector 106 can define one or more boundaries (e.g., boundary lines) between portions of a map exceeding the threshold 124, and portions which do not exceed the threshold 124. An example boundary line is depicted in FIG. 3B. The boundary projector 106 can define constituent grids (e.g., a higher resolution grid) or polynomial functions corresponding to a threshold 124. For example, for an opacity map including values between zero and one, a threshold 124 (e.g., 0.5) can be received by the boundary projector, e.g., from the map sampler 102. The sampling function can result in smoothing such that, for a gradient value equal to the threshold 124, a boundary line can be defined. That is, where a rasterized image includes some portions (e.g., pixels) exceeding the threshold 124, and other portions (e.g., pixels) subceeding the threshold 124, the boundary can be a line disposed between the respective portions that corresponds to the threshold 124.

The boundary projector 106 can delineate one or more portions of a data map 126 which exceeds a threshold 124 from one or more portions which do not, a boundary line referring to the threshold separating the respective portions. For example, the boundary projector 106 can determine a polynomial function corresponding to the line, such that the boundary can be defined over a surface of the map 126. That is, the boundary projector can define a boundary line for the data map 126, corresponding to the threshold 124.

Conceptually, or according to a graphical representation, the boundary can define an intersection of a two-dimensional threshold plane with a three-dimensional representation of the data map 126. The three-dimensional representation can correspond to two spatial dimensions and a visual characteristic dimension. That is, a portion of the three-dimensional representation of a data map 126 on one side of the two-dimensional threshold plane can be defined according to one state, a portion of the three dimensional representation of a data map 126 on another side of the two-dimensional threshold plane can be defined as another state, and the intersection can be referred to as a boundary (e.g., a boundary line, which can include a geometric line lacking width, for some data maps 126). Shape elements in or straddling a boundary can be mixed state shape elements.

The boundary projector 106 can receive one or more thresholds 124, such that one or more boundary lines can be generated corresponding to the respective thresholds 124. For example, the boundary projector 106 can define a first boundary line corresponding to an opacity threshold 124 of 0.66, a second boundary line corresponding to an opacity threshold 124 of 0.5, and a third boundary line corresponding to an opacity threshold 124 of 0.33. As viewed over an opaque object (e.g., a leaf of a tree, a table leg, or so forth), the boundary lines can concentrically surround the objects, wherein boundary lines corresponding to lower thresholds 124 surround boundary lines corresponding to higher thresholds 124. According to a geometry of the opaque object, the outer lines can merge with further boundary lines, or portions thereof.

The characteristic identifier 108 can determine a state of one or more locations (e.g., points) of a triangle (e.g., the shape element) by comparing a value corresponding to the visual characteristic to the threshold 124 of the data map 126. For example, the characteristic identifier 108 can determine a state of one or more shape elements bounding a center of a grid cell. Although the example refers to the center points of grid cells, which may be a local maximum or minimum in the case of bilinear sampling, such an example is not limiting. For example, according to some implementations, a sampling point can include a first, second, or third vertex, or another portion of a shape.

Wherein the characteristic identifier 108 determines a state corresponding to at least two locations associated with the shape element, the characteristic identifier 108 can determine if those shape elements are equal or non-equal to each other. For example, the characteristic identifier 108 can compare every center of a grid cell bounded by the triangle to a (same) predefined threshold 124.

If a shape element includes two or more locations which differ in state from each other (e.g., one exceeding the threshold 124, and one not exceeding the threshold 124), then the shape element is mixed state and may not be resolved (as depicted in FIG. 3D). If the locations associated with a shape element do not differ in state (as depicted in FIG. 3E), then the shape element may not be mixed state. However, according to a sampling technique, a further test may be employed. For example, a bicubic sampling technique can be employed in combination with island-testing or interstitial-testing, or a bilinear sampling technique can be employed in combination with intersection-testing. Intersection-testing can refer to determining a presence of an intersection between a shape element and a boundary line. For example, intersection-testing can include determining an intersection between an edge of a polygon with a boundary line, a determination that cell centers or vertices straddle a boundary line, or so forth.

The characteristic identifier 108 can determine an intersection between a line connecting two vertices of the triangle, and the boundary. For example, the characteristic identifier 108 can determine whether any intersection exists along an infinite line, and thereafter test for whether the intersection is bounded by the vertices' points, or otherwise determine whether an intersection exists. For example, for a triangle, the characteristic identifier 108 can determine that the intersection with the line for a first edge of the triangle intermediates further intersections between the line and other lines corresponding to a second and third edge of the triangle, the further intersections each corresponding to respective vertices of the triangle. The characteristic identifier 108 can determine the intersection for any number of lines, such as a function-defined line of an irregular shape, a straight line of a regular polygon (e.g., triangular shape element), or so forth. An example of intersection-testing is depicted at FIG. 3E.

The characteristic identifier 108 can define a state (e.g., of a shape or shape element) according to an intersection test. For example, for a shape which includes no mixed states of tested locations, and no intersections with a boundary, the characteristic identifier 108 can determine that a shape is not mixed and can assign a state according to the one or more locations. For example, if a vertex of a shape element or every cell center of a shape element is opaque, and the shape element does not intersect with a boundary line, then the characteristic identifier 108 can assign a state corresponding to opacity.

In some implementations, the characteristic identifier 108 can identify a shape based on every location of the shape (e.g., a shape which is 99.9% opaque can be defined as mixed-stated). At run-time, a device can identify interactions between rays and a mixed shape element to determine a portion of the shape the ray is interacting with.

In some implementations, the threshold 124 accessed by the characteristic identifier 108 can include a plurality of thresholds including the boundary line threshold as well as an area threshold, which may reduce a number of mixed state shapes. For example, the characteristic identifier 108 can further determine an area, number of vertices, number of cells, etc., and can compare the measure to a threshold 124 to define the state. The characteristic identifier 108 can determine an area corresponding to a first state and an area corresponding to a second state. The characteristic identifier 108 can classify a shape element based on a comparison of the first area to the second area. For example, the characteristic identifier 108 can define shapes exceeding 90% opaque as opaque, between 10% and 90% as mixed state, and between 0% and 10% as transparent. The characteristic identifier 108 can define shapes exceeding 75% opaque as opaque, between 25% and 75% as mixed state, and between 0% and 25% as transparent. The characteristic identifier 108 can define shapes exceeding 50% opaque as opaque and subceeding 50% as transparent. The characteristic identifier 108 can store one or more values in a data structure of the LUT 122. At run-time, a device can select a portion from the LUT 122 according to a quality setting, dynamic performance, a presence of particular hardware circuits or driver settings, or so forth.

The UV mapper 110 can associate a two dimensional data map 126 with a surface of a three-dimensional data object 128, wherein the three-dimensional data object 128 includes at least one facing of a three-dimensional object 128 (e.g., a facing of a wall or the sky), and can include many facings (e.g., the various facial features of a human of other characters). The UV mapper 110 can flatten (e.g., unwrap) the three-dimensional object 128, according to various projections. The UV mapper 110 can associate the shape elements of the dimensional data map 126 with the facings of the data objects. For example, the UV mapper 110 can include a UV map data structure that includes two dimensional (e.g., u, v) data in a first, two-dimensional frame of reference, which is associated with three dimensional (e.g., x, y, z) data in a three-dimensional frame of reference in which the three-dimensional object 128 is to be rendered. The UV mapper 110 can further adjust seams associated with the projection, and can apply the texture to the three-dimensional object 128 (e.g., reversing the unwrapping).

The UV mapper 110 can include one or more components. For example, the flattening and texture association can be performed at a first set of circuits to generate a three-dimensional object 128, can unwrap the three-dimensional object 128, and can map the texture to the three-dimensional object 128. The textured three-dimensional object 128 may be conveyed to another component of the data processing system 100 (e.g., a run-time device) to render the received three-dimensional object 128, or further adjust a texture mapping associated therewith.

The ray projector 112 can project rays in a virtual environment, such as a three-dimensional environment. The rays can extend from an origin along a path of travel. The ray projector can identify an interface between the ray and one or more three-dimensional data objects 128. For example, the ray projector 112 can determine an interface with a shape element of a first three-dimensional data object 128. The shape element of the first three-dimensional data object 128 can include only interstitial space or may otherwise be transparent. The ray projector 112 can access a LUT 122 associated with the shape element and determine that the shape element is transparent based on the access (e.g., according to a bit flag stored in the LUT 122). The ray projector 112 can determine that the ray should proceed through the first three-dimensional data object 128 based on the transparency thereof.

The ray projector 112 can identify an interface between the ray and a shape element of a second three-dimensional data object 128 (or another portion of the first data object). The ray projector 112 can access a LUT 122 associated with the shape element and determine that the shape element is a mixed state shape element based on the access (e.g., according to a bit flag stored in the LUT 122). That is, the shape element can include both transparent and opaque portions (e.g., according to a transparency threshold 124). The ray projector 112 can perform a secondary check to determine a portion of the shape element that the ray interfaces. For example, the ray projector 112 can retrieve the data map 126 from a memory location to determine a state of the point of intersection. The ray projector 112 can determine, for example, that the intersection is with a transparent portion, and should proceed beyond the second three-dimensional data object 128.

The secondary check can incur delay, as the data map 126 is retrieved from memory, and an intersection point is computed. Further, the secondary check can cause an increase in power use by a computing device implementing or otherwise associated with the ray projector 112. Moreover, wherein certain further operations may be pipelined with the ray projection, or may share common resources (e.g., raytracing acceleration hardware), further operations of a computing device or system can be deferred or omitted while the ray projector 112 conducts the secondary check. For example, the further propagation of the ray beyond the second three-dimensional data object 128 may be pipelined with the determination to cause a delay of such a determination, or further power and compute resources may be employed to determine the propagation based on a potential branch.

The ray projector 112 can identify an interface between the ray and a shape element of a third three-dimensional data object 128 (or another portion of the first or second data objects). The shape element of the third three-dimensional data object 128 can include only opaque surfaces. The ray projector 112 can access a LUT 122 associated with the shape element and can determine that the shape element is opaque based on the access (e.g., according to a bit flag stored in the LUT 122). The ray projector 112 can determine that the ray should not proceed through the third three-dimensional data object 128 based on the opacity thereof (e.g., should terminate, reflect, etc.).

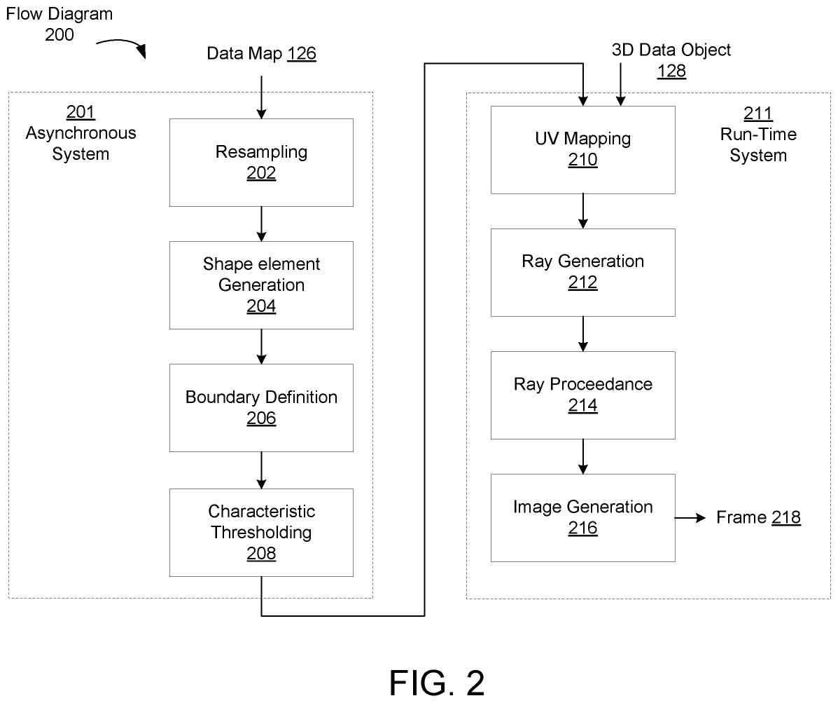

FIG. 2 is a flow diagram 200 of an example of a data flow to generate a ray traced image. The flow can include one or more computing devices of a data processing system 100. Particularly, an asynchronous system 201 and a run-time system 211 are presented according to an illustrative example. The asynchronous system 201 receive a data map 126, such as a texture map 126, object, or other representation of a digital asset. Like other illustrative examples of the present disclosure, the example if FIG. 2 is not intended to be limiting. For example, the asynchronous system 201 and run-time system 211 can be implemented on a same or different computing devices, and/or the operations described with reference to FIG. 2 can be performed in various sequences or orders or computing systems relating to such orders, including but not limited to any one or more of asynchronous, synchronous, pre-pass, and/or at run-time, according to some aspects. That is, as indicated above with regard to a first sub-system and second sub-system, aspects of the present disclosure can be implemented on one or more computing devices of, for example, FIG. 6 or FIG. 7.

The data processing system 100 can perform resampling 202 of the data map 126 to generate another representation thereof. For example, the representation can include a gradient corresponding to a visual characteristic of the data map 126. In some implementations, the representation can include two spatial dimensions and a further dimension corresponding to a gradation of at least one visual characteristic.

The data processing system 100 can perform shape element generation 204. For example, the shapes can be generated prior or subsequent to the resampling 202 of the data map 126. That is, the shape elements can be generated as an overlay over the data map 126, wherein the shape elements are not altered by a transformation (e.g., resampling 202) of the data map 126. For example, the shape elements can include triangles or other polygons subdivided into constituent shape elements (e.g., tessellated into micro-triangles). An example of shape elements generated with respect to a data map 126 is provided at FIG. 3C, henceforth.

The data processing system 100 can perform boundary definition 206 to define a boundary of the data map 126. For example, the boundary can separate one or more portions of the data map 126 which exceeds a threshold 124 from one or more portions which do not. An example boundary defined according to a boundary definition 206 operation is depicted henceforth, at FIG. 3B.

The data processing system 100 can perform characteristic thresholding 208 (e.g., alpha testing) with regard to a visual characteristic. For example, the characteristic thresholding 208 can be performed on a shape element basis to determine a state of the shape elements, the state corresponding to one or more visual characteristics. Thus, according to the thresholding, the characteristic identifier 108 can assign various states corresponding to the visual characteristic. The assignment can include a binary or other classification. Some shape elements may be mixed state, such that an assignment of a state can indicate the mixed state thereof. As indicated above, in some implementations, mixed states can be fully or partially resolved by reference to one or more further thresholds 124 (e.g., a percent of a shape element or number of vertices, such as three out of three vertices of a micro-triangle).

The data processing system 100 can perform various UV mapping 210 operations, such as a first portion of mapping operations to texturize a data object at an asynchronous system 201, and a second portion of operations to adjust the texture to render the data object at a run-time (e.g., synchronous) system. That is, the asynchronous system 201 can convey a texture of the data object to another computing device (e.g., a run-time system 211). The run-time system 211 can be or include a desktop or laptop personal computer, mobile device, point of sale (POS) device, or other computing device configured to generate ray-traced graphical output frames. The conveyance can be direct or indirect. For example, the asynchronous system 201 and the run-time system 211 can be in direct communication, or in network communication wherein at least one of the asynchronous system 201 or the run-time system 211 is addressable by the other of the asynchronous system 201 or the run-time system 211. In some implementations, the asynchronous system 201 can convey the image to the run-time system 211 as a portion of an executable package, or other data assemblage (e.g., the asynchronous system 201 and run-time system 211 may not be addressable by each other).

The run-time system 211 can map a received data map 126 to a three-dimensional data object 128, or can receive a pre-textured three-dimensional data object 128. For example, the run-time system 211 can receive the three-dimensional data object 128 from the asynchronous system 201 or another source. The run-time system 211 can render the three-dimensional data object 128 including information from the data map 126 (e.g., as a texture, disposed over surfaces of the three-dimensional data object 128).

The run-time system 211 can perform ray generation 212 to generate any number of rays from an origin point, such as a light source, virtual camera, point of view or other portion of an environment. The rays can extend until interfacing with a data object. For example, one or more rays can interface (e.g., intersect) with a shape element of the three-dimensional data object 128.

The run-time system 211 can determine a ray propagation 214, based on a visual characteristic of the shape element. The visual characteristic can be stored as a state of the shape element (e.g., in a state register, lookup table, or other data structure of the LUT 122). For example, the visual characteristic can indicate an opacity, such as according to an opacity bit providing a binary indication of a transparent or opaque state for the shape element (e.g., an intersection with an edge or other portion of a shape element), or a mixed state bit providing an indication of a mixed state, whereupon the run-time device 211 can retrieve a data map 126 from a memory location and determine a state of a point of intersection with the ray.

The run-time system 211 can perform image generation 216 of a further image (e.g., a frame 218) based on the ray propagation 214, such as to determine a lighting effect, a line of sight between two characters or items, etc. The run-time system 211 can present the frame 218 to a user, such as a user of a virtual reality, augmented reality, or other graphical interface (e.g., desktop computer or mobile device screen).

FIGS. 3A, 3B, 3C, 3D, and 3E are depictions of an image 300 processed according to image state mapping, according to the present disclosure. FIG. 3A depicts a raster image 300 including an indication of opacity information. Particularly, opaque pixels are provided, corresponding to an opacity state of one. Transparent pixels are provided, corresponding to an opacity state of zero. According to some implementations, the pixel data can include gradated values (e.g., other than one or zero). The opaque pixels, collectively, can depict a feature 306 of the image 300. The transparent pixels, collectively, can depict an environment 304 around the feature 306. The raster image 300 is provided according to a grid 302.

Referring now to FIG. 3B, a further image 300 depicting a data map 126 for a resampling of the raster image 300 of FIG. 3A. The resampling is further thresholded according to a predefined threshold 124 (e.g., alpha tested) to yield the depicted binary (black and white) states. Prior to thresholding (e.g., alpha testing), a gradient can extend between the black and white portions.

The image 300 is presented as two-dimensional (e.g., according to an x-dimension and a y-dimension). A third dimension (not depicted) can depict a gradation of a visible characteristic, such as the opacity, according to as scale extending from 0 to 1. The thresholding (e.g., alpha testing) can collapse the third dimension to a binary dimension presented according to the white and black portions of the depicted image 300. For example, the sampling can be a bilinear sampling, wherein the predefined threshold 124 of 0.5 is selected for the thresholding.

An outer border of the feature of the data map 126 defines a boundary line 308 between the transparent and opaque portions of the data map 126. Various boundaries can correspond to various data maps 126. For example, some data maps 126 can depict two or more features 306 which are separated from one another. For example, according to some resampling operations, the depicted figure could include separate portions, such that multiple non-contiguous boundary lines may be present. Further, the various boundary lines can intersect, merge, occupy area, or so forth.

Referring now to FIG. 3C, a representation of a data map 126 is provided. The depicted representation of the data map 126 includes a boundary line 308 corresponding to a threshold 124 associated with a visual characteristic (e.g., an alpha cutoff of 0.5). For example, a feature 306 of the data map 126 is depicted in relation to an environment 304, as separated by the boundary line 308. That is, areas interior to the boundary line 308 are opaque and areas exterior to the boundary line 308 are transparent. The first shape element 310 is overlaid over the representation of the data map 126.

The first shape element 310 is subdivided (tessellated) into various constituent shape elements according to a repeating pattern thereof. The constituent shape elements are disposed according to a same size and a repeating pattern (e.g., micro-triangles). A first set 312 of the constituent shape elements are exterior to the boundary line 308. According to a three-dimensional representation of the data map 126, a ray intersecting any portion of a micro-triangle of the first set 312 can interface with a transparent portion. For example, at run-time, a circuit can retrieve a predefined state value associated with the one or more micro-triangles of the first set 312.

A second set 314 of the constituent shape elements are interior to the boundary line 308. According to a three-dimensional representation of the data map 126, a ray intersecting any portion of a micro-triangle of the second set 314 can interface with an opaque portion. For example, at run-time, a circuit can retrieve a predefined state value associated with the one or more micro-triangles of the second set 314.

A third set 316 of the constituent shape elements intersect the boundary line 308. The third set 316 of the constituent shape elements are thus mixed states, and may not be resolved according to a non-lossy implementation (e.g., an implementation that does not resolve mixed state shape elements to an approximated resolved state). According to a three-dimensional representation of the data map 126, the propagation of a ray interfacing with a micro-triangle of the third set 316 may not correspond to a single predefined state.

Referring now to FIG. 3D, a state determination (e.g., characteristic thresholding 208) is performed with respect to a second shape element 318 (e.g., micro triangle). The second shape element 318 corresponds to a shape element of the third set 316 (e.g., straddles the boundary line 308). The second shape element 318 is depicted as differently sized and disposed, relative to the tessellated micro-triangles of the first shape element 310 of FIG. 3C, merely to aid the clarity of the features provided herein. Like other figures, features are not necessarily depicted to scale, and indeed, may be intentionally increased or decreased in size to emphasize or clearly illustrate certain figures. In various implementations, various shape element sizes, dispositions, etc. may be practiced.

The second shape element 318 bounds various center points of cells of a grid 302. One or more locations disposed within the second shape element 318 include a first location 320, second location 322, third location 324, and fourth location 326. Each of the locations can correspond to a center of a cell. In various implementations, the locations can correspond to further locations of the second shape element 318. Each location can be compared to an opacity threshold 124 to determine a state associated therewith. Particularly, the characteristic identifier 108 can associate the first location 320, second location 322, and third location 324 to a transparent state. The characteristic identifier 108 can associate the fourth location 326 with an opaque state. Wherein the second shape element 318 includes some portions which are different states, the characteristic identifier 108 can assign the second shape element 318 as mixed state (e.g., may not perform an intersection test).

Referring now to FIG. 3E, a state determination is performed with respect to a third shape element 328 (e.g., micro triangle). One or more locations within the third shape element 328 (e.g., the centers of the cells of the grid 302) all correspond to a same state. Particularly, a first location 330, second location 332, and third location 334 correspond to a transparent state. According to the same stated-ness of the locations, the data processing system 100 can employ further checks (e.g., vertex checking, edge intersection checking, or another technique).

A further check can include detecting an intersection. For example, the characteristic identifier 108 can determine an intersection between a first line 336 corresponding to an edge of the triangle, and the boundary line 308 between two vertices of the third shape element 328. The characteristic identifier 108 can further determine an intersection between the boundary line 308 and a second line 338 or a third line 340, corresponding to other sides of the third shape element 328. The characteristic identifier 108 can determine, based on the intersection, that the third shape element 328 is a mixed state shape element (e.g., belongs to the third set 316 of FIG. 3C).

For a determination of zero intersection, the characteristic identifier 108 can determine, based on the intersections and the state of the one or more locations, that the third shape element 328 is a transparent shape element (e.g., belongs to the first set 312 of FIG. 3C). For a determination of zero intersections, and one or more location which are opaque, the characteristic identifier 108 can determine, based on the intersections and the state of the one or more locations, that the third shape element 328 is an opaque shape element (e.g., belongs to the second set 314 of FIG. 3C).

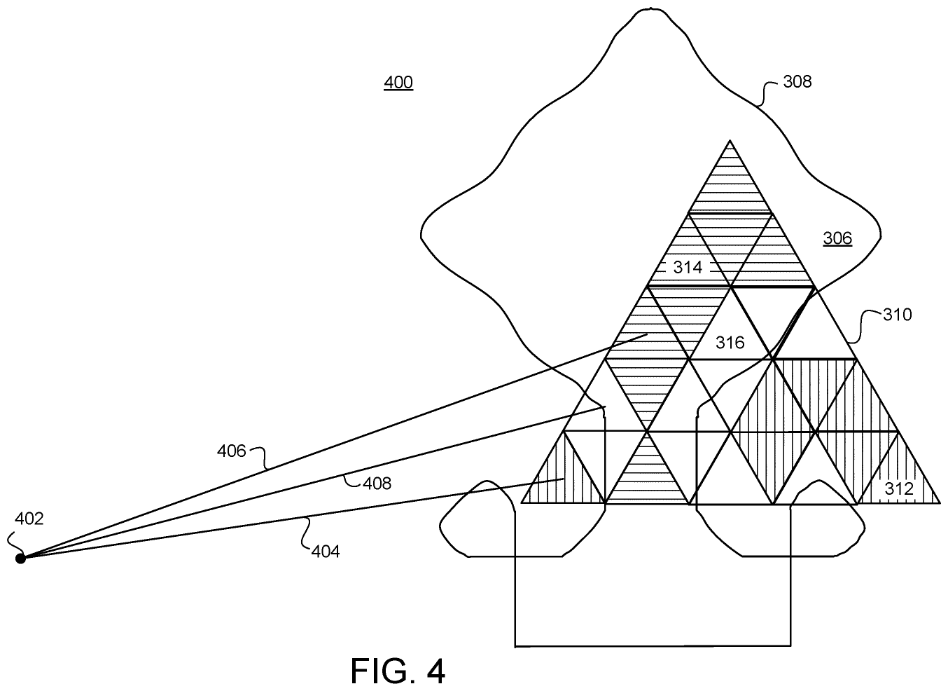

Now referring to FIG. 4, a graphical environment 400 including a feature 306 is depicted. One or more circuits of the data processing system 100 can determine ray propagation in the graphical environment 400. The first shape element 310 of FIG. 3C is provided in a graphical environment 400 to depict shape elements of varying states (e.g., the constituent shape elements of the first shape element 310).

The first shape element 310 can be depicted on a surface of a three-dimensional data object 128. Merely for the clarity of the figure, the first shape element 310 is depicted according to a frontal view. Various other shape elements (not depicted) can be presented according to various oblique or angled views (e.g., over various facings of a three dimensional data object 128). The data processing system 100 (e.g., the run-time device 211) can render a representation of the feature 306 of FIG. 3C, along with a texture, environment, other three-dimensional data objects 128, and so forth.

The environment 400 can include one or more origins 402, such as light sources, or a point of view from a virtual reality perspective. Any number of rays can proceed from the origin which can interact with one or more shape elements of one or more three-dimensional data objects 128.

Ray propagation can be determined according to an interaction with a shape element at an interface therewith. For example, the data processing system 100 can determine that a first ray 404 interfaces with a shape element of the first set 312. The data processing system 100 can retrieve a state associated with such a shape element from a LUT 122. The state can indicate that the shape corresponds to a visual characteristic (transparent) and determine that the ray should propagate. The data processing system 100 can determine that a second ray 406 interfaces with a shape element of the second set 314. The data processing system 100 can retrieve a state associated with such a shape element from a LUT 122. The state can indicate that the shape corresponds to a visual characteristic (opaque) and determine that the ray should terminate.

Wherein at least a portion of the shape elements are mixed state, the data processing can determine that some rays, including a depicted third ray 408, interface with a shape element which is mixed state. To resolve an interface between a ray and the mixed state shape element, the data processing system can retrieve a data map 126, such as a texture map 126 or portion thereof, or other representation of the feature 306, to determine a state of the feature 306 at a point of intersection with the third ray 408. Such a determination can induce latency, increased energy use, or employ additional hardware accelerators of a circuit.

Reducing a number of determinations which are not retrieved from the LUT 122 can aid system performance. For example, the depicted first shape element 310 includes ten mixed state constituent shape elements, and fifteen resolved constituent shape elements (eight opaque micro-triangles, and seven transparent micro-triangles). For an instance randomly distributing rays, such an implementation can achieve performance increases, reductions in a number of raytracing circuits, or so forth.

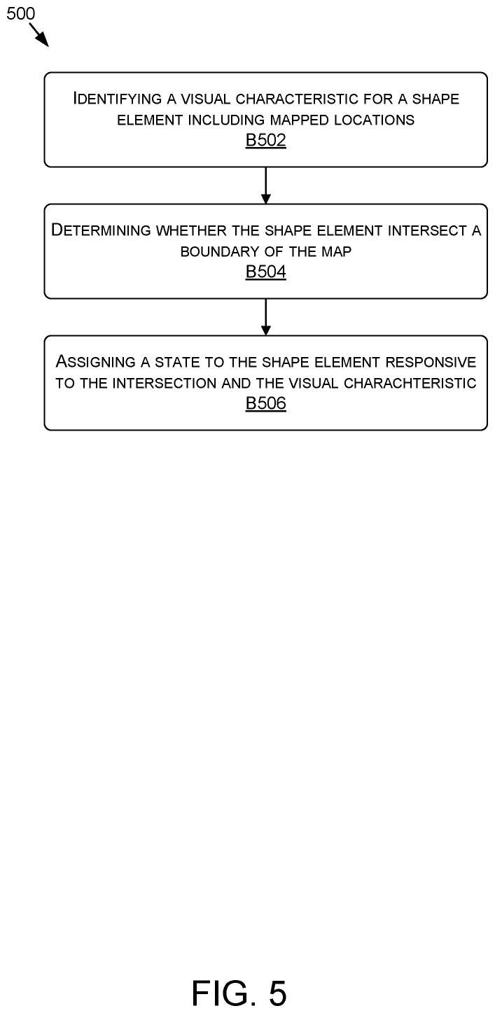

Now referring to FIG. 5, each block of the method 500, described herein, comprises a computing process that may be performed using any combination of hardware, firmware, and/or software. For instance, various functions may be carried out by a processor executing instructions stored in memory, including the data processing system 100 of FIG. 1. The method 500 may also be embodied as computer-usable instructions stored on computer storage media. The method 500 may be provided by a standalone application, a service or hosted service (standalone or in combination with another hosted service), or a plug-in to another product, to name a few. In addition, the method 500 is described, by way of example, with respect to the data processing system of FIG. 1. However, this method 500 may additionally or alternatively be executed by any one system, or any combination of systems, including, but not limited to, those described herein.

FIG. 5 is a flow diagram showing a method 500 for image state mapping, in accordance with some implementations of the present disclosure. Various operations of the method 500 can be implemented by the same or different devices or entities at various points in time. For example, one or more first devices may implement operations relating to identifying a state associated with one or more visual characteristics (characteristic thresholding 208). One or more second devices, such as a client run-time device, may implement operations such as ray propagation 214 to generate frames for presentation.

The method 500, at block B502, includes identifying a visual characteristic for a shape element mapped to a plurality of locations of a map 126. The identification can be at one or more points of the shape element. For example, the identification can be at vertices of polygons or other shapes, centers, along edges, or other locations. The identification can be with respect to another portion of the data map 126, such as a grid 302. For example, the identification can be at one or more cell centers, vertices, intersections, or other locations relative to the grid.

The identification can include a comparison to one or more thresholds 124. For example, the identification can include comparing an opacity of a data map 126 (e.g., opacity micro-map 126) to a predefined threshold 124 (e.g., to alpha-test the image). The identification can include two or more states corresponding to one or more visual characteristics. Continuing the example of an opacity map 126, the states can relate to a transparency, opacity, or mixed stated-ness. The state can be a candidate state, relative to comparisons to other portions, or other operations such as the other operations described herein.

The method 500, at block B504, includes determining whether the shape element intersects a boundary of the map. The boundary can correspond to a threshold value for the visual characteristic. For example, the boundary can correspond to a boundary between a portion of the data map 126 which exceeds the threshold 124 from a portion of the data map 126 which does not exceed the threshold 124. Thus, an intersection with the boundary can determine that a shape element is a mixed state shape element. Conversely, a non-intersection with the boundary can determine that a shape element is a resolved state shape element, or is a candidate for being a resolved state shape element. That is, a shape element including an island or interstitial space may be a mixed state shape element, even where no intersection is present along an edge of the shape element.

The method 500, at block B506, includes assigning a state for controlling generation of an image including the shape element to the shape element. The assignment can be an assignment of one or more bit flags, such as a two-bit value corresponding to a binary indication of a visual characteristic and an indication of mixed stated-ness. The assignment can be to a data structure configured for conveyance to a ray generating device, such as a state register of a LUT 122. The ray generating device can include a client device configured to generate rays (e.g., at run-time), such as a personal computer, mobile device (e.g., cellular device or wearable device, such as a watch or AR goggles).

The assignment can be responsive to the determination of the intersection and according to the visual characteristic. For example, an assignment of mixed stated-ness can be responsive to a determination of at least one location of the shape element having a state, along with an absence of an intersection. For example, if one or more locations of a shape element are transparent, the shape is not opaque. Further, according to some sampling techniques, such as bilinear sampling, the presence of islands or interstitial space can be excluded responsive to an indication that particular locations (e.g., corresponding to a grid 302) are all of a same type.

According to various implementations, a selection of locations of a shape can vary. For example, for a shape which is less than a dimension of a grid, a vertex check can exclude islands or interstitial space. When combined with the intersection, the shape can be assigned a state. For example, the data processing system 100 can a determine a lack of islands or interstitial space in combination with a lack of an intersection, in combination with at least one point of a known state corresponds the every portion of shape element being the known state. The data processing system 100 can accordingly assign the known state to the shape element.

### Example Computing Device

FIG. 6 is a block diagram of an example computing device(s) 600 suitable for use in implementing some implementations of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one implementation, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some implementations, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may be arranged in various topologies, including but not limited to bus, star, ring, mesh, tree, or hybrid topologies. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In some implementations, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU), such as to implement one or more operations described with reference to the system 100. The GPU(s) 608 may include hundreds or thousands of cores that are capable of handling hundreds or thousands of software threads simultaneously (e.g., to render an image including a 3D data structure 128). The GPU(s) 608 may generate pixel data for output images (e.g., frames 218) or other data structures in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In implementations, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In implementations, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Raytracing hardware Accelerator Cores (RTs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 620 and/or communication interface 610 may include one or more data processing units (DPUs) to transmit data received over a network and/or through interconnect system 602 directly to (e.g., a memory of) one or more GPU(s) 608. In some implementations, a plurality of computing devices 600 or components thereof, which may be similar or different to one another in various respects, can be communicatively coupled to transmit and receive data for performing various operations described herein, such as to facilitate latency reduction.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, CNC machine, laser cutting tool, machine vision system, etc. The I/O components 614 may provide a natural user interface (NUI) that processes air gestures, voice, or other physiological inputs generated by a user. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). The presentation component(s) 618 may include communicative connections configured to output various data structures comprising raytraced images generated according to the systems and methods disclosed herein.

### Example Data Center

FIG. 7 illustrates an example data center 700 that may be used in at least one implementation of the present disclosure, such as to implement the data processing system 100 in one or more examples of the data center 700. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one implementation, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 716(1)-716(N) may correspond to a server having one or more of the above-mentioned computing resources. In addition, in some implementations, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one implementation, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one implementation, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one implementation, resource orchestrator 712 may include a software design infrastructure (SDI) management entity for the data center 700. The resource orchestrator 712 may include hardware, software, or some combination thereof.

In at least one implementation, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one implementation, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one implementation, clustered or grouped computing resources may include grouped computing resource 714 at data center infrastructure layer 710. The resource manager 736 may coordinate with resource orchestrator 712 to manage these mapped or allocated computing resources.

In at least one implementation, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one implementation, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), simulation software for rendering and updating simulated or virtual environments and/or other machine learning applications used in conjunction with one or more implementations, such as to train, configure, update, and/or execute machine learning models.

In at least one implementation, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more implementations described herein. In at least one implementation, trained or deployed machine learning models corresponding to one or more neural networks may be used to infer or predict information using resources described above with respect to the data center 700 by using weight parameters calculated through one or more training techniques, such as but not limited to those described herein.

In at least one implementation, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. Such an interpretation should not be interpreted to limit recitations of “or” which may refer to one or more or elements of a set of elements of a set. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
identify a visual characteristic for a shape element mapped to a plurality of locations of a texture map;
determine whether the shape element intersects a boundary of the texture map, the boundary corresponding to a threshold value for the visual characteristic; and
assign, responsive to the determination of the intersection and according to the visual characteristic, a state to the shape element to control generation of an image comprising the shape element.

2. The processor of claim 1, comprising:
one or more second circuits to:
identify an interface between a simulated ray and the shape element; and
determine an absorption or propagation of the simulated ray at the interface according to a criterion corresponding to the state of the shape element.

3. The processor of claim 1, comprising:
one or more second circuits to:
identify an interface between a simulated ray and the shape element;
retrieve, responsive to the state of the shape element, a representation of the shape element comprising an indication of the boundary; and
determine an absorption or propagation of the simulated ray at the interface according to criteria comprising the state of the representation of the shape element.

4. The processor of claim 1, wherein the state assigned to the shape element is represented using:
a first bit, indicative of the intersection with the boundary; and
a second bit, indicative of the visual characteristic.

5. The processor of claim 1, wherein a location of the plurality of locations comprises a center point of a cell disposed in a grid.

6. The processor of claim 5, wherein the boundary is defined according to a polynomial function of the grid.

7. The processor of claim 1, wherein the texture map is a two-dimensional texture map that maps a projection of a three-dimensional data object two a two-dimensional image.

8. The processor of claim 1, wherein the boundary is defined according to a bilinear sampling of a two-dimensional texture map.

9. The processor of claim 1 wherein:
the visual characteristic is a binary indication of an opacity;
the shape element is a triangle; and
the opacity is identified by comparing a map location bounded by the triangle to the threshold value.

10. The processor of claim 1, wherein the processor is comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system implementing one or more large language models (LLMs);
a system for performing conversational AI operations;
a system for generating synthetic data;
a system incorporating one or more virtual machines (VMs);
a system implemented at least partially in a data center; or
a system implemented at least partially using cloud computing resources.

11. A system comprising:
one or more circuits to:
identify, for a shape element mapped to a plurality of locations of a texture map, a visual characteristic;
determine whether the shape element intersects a boundary of the texture map, the boundary corresponding to a threshold value for the visual characteristic; and
assign, responsive to the determination of the intersection and according to the visual characteristic, a state to the shape element to control generation of an image comprising the shape element.

12. The system of claim 11, comprising:
one or more second circuits to:
identify an interface between a ray and the shape element; and
determine an absorption or propagation of the ray at the interface according to a criterion corresponding to the state of the shape element.

13. The system of claim 11, comprising:
one or more second circuits to:
identify an interface between a ray and the shape element;
retrieve, responsive to the state of the shape element, a representation of the shape element comprising an indication of the boundary; and
determine at least one of an absorption or a propagation of the ray at the interface according to criteria determined based at least on the state of the representation of the shape element.

14. The system of claim 11, wherein the state assigned to the shape element is represented using:
a first bit, indicative of the intersection with the boundary; and
a second bit, indicative of the visual characteristic.

15. The system of claim 11, wherein the texture map is a two-dimensional texture map, and the boundary is defined according to a bilinear sampling of the two-dimensional texture map.

16. The system of claim 11 wherein:
the visual characteristic is a binary indication of an opacity;
the shape element is a triangle; and
the opacity is identified by comparing a map location bounded by the triangle to the threshold value.

17. A method comprising:
identifying, using a data processing system, a visual characteristic corresponding to a shape element mapped to a plurality of locations of a texture map;
determining, by the data processing system, whether the shape element intersects a boundary of the texture map, the boundary corresponding to a threshold value for the visual characteristic; and
assigning, by the data processing system, to the shape element, a state for controlling generation of an image comprising the shape element, responsive to the determination of the intersection and according to the visual characteristic.

18. The method of claim 17, wherein:
a location of the plurality of locations comprises a center point of a cell disposed in a grid;
the boundary is defined according to a polynomial function of the grid; and
the state is represented using:
a first bit, indicative of the intersection with the boundary; and
a second bit, indicative of the visual characteristic.

19. The method of claim 17, wherein:
the texture map is a two-dimensional texture map that maps a three-dimensional data object to a two-dimensional image; and
the boundary is defined according to a bilinear sampling of the two-dimensional texture map.

20. The method of claim 17 wherein:
the visual characteristic is a binary indication of an opacity;
the shape element is a triangle; and
the opacity is identified by comparing a map location bounded by the triangle to the threshold value.
